(19) United States
(12) Patent Application Publication
(10) Pub. No.: US 2018/0268280 A1
(43) Pub. Date: Sep. 20, 2018

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 15/698,972

(22) Filed: Sep. 8, 2017

(30) Foreign Application Priority Data
Mar. 14, 2017 (JP) 2017-048618

(51) Int. Cl. G06N 3/00; B25J 11/00; B25J 9/16; G06N 3/04

(52) U.S. Cl. CPC G06N 3/008; B25J 11/0005; G06N 3/0454; B25J 9/162; B25J 9/163

(57) ABSTRACT

An information processing apparatus includes a first artificial intelligence that outputs a first result by processing input information, and a second artificial intelligence that is different from the first artificial intelligence, and outputs a second result by processing the input information. Content of a process to be performed next is determined, based on results obtained by comparing the first result with the second result.

### CROSS-REFERENCE TO RELATED APPLICATIONS

This application is based on and claims priority under 35 USC 119 from Japanese Patent Application No. 2017-048618 filed Mar. 14, 2017.

### BACKGROUND

### (i) Technical Field

The present invention relates to an information processing apparatus, an information processing system, and a non-transitory computer readable medium.

### (ii) Related Art

The use of artificial intelligences in robots assisting people in daily life (such as a cleaning robot or a communication robot) is under way, and there is a growing demand for reliability in process and operation of the artificial intelligence.

### SUMMARY

According to an aspect of the invention, there is provided an information processing apparatus. The information processing apparatus includes a first artificial intelligence that outputs a first result by processing input information and a second artificial intelligence that is different from the first artificial intelligence, and outputs a second result by processing the input information. Content of a process to be performed next is determined, based on results obtained by comparing the first result with the second result.

### BRIEF DESCRIPTION OF THE DRAWINGS

Exemplary embodiment of the present invention will be described in detail based on the following figures, wherein:

FIG. 1 is an external view of a robot that is an example of an information processing apparatus;

FIG. 2 illustrates a hardware configuration of a robot for use in an exemplary embodiment;

FIG. 3 illustrates a usage example of calculation resources provided by the robot;

FIG. 4 illustrates a mechanism through which two process results are combined via a process functionality other than those of two artificial intelligences;

FIG. 5 illustrates a mechanism through which two process results are combined by one of the two artificial intelligences;

FIG. 6 illustrates a coordinated operation between a real space and a virtual space;

FIG. 7 illustrates a hardware configuration of a terminal apparatus;

FIG. 8 illustrates a display example on a display screen;

FIG. 9 illustrates another display example on the display screen;

FIG. 10 illustrates another display example on the display screen;

FIG. 11 illustrates another display example on the display screen;

FIG. 12 illustrates another display example on the display screen;

FIG. 13 illustrates a process in which an artificial intelligence moves;

FIG. 14 illustrates a display example on a display screen responsive to a movement process of an artificial intelligence;

FIG. 15 illustrates a state in which the movement of the artificial intelligence is complete;

FIG. 16 illustrates a display example on a display screen responsive to a phase in which the movement of the artificial intelligence is complete;

FIG. 17 illustrates an operation example in which an artificial intelligence having a worker's role and an artificial intelligence having a monitor's role operate in separate apparatuses;

FIG. 18 illustrates a combined operation of two results when two artificial intelligences operate in separate apparatuses;

FIG. 19 illustrates a display example on a display screen when artificial intelligences operate in separate apparatuses; and

FIG. 20 illustrates how a working location of an artificial intelligence moves in concert with an operation performed on a character on the display screen.

### DETAILED DESCRIPTION

An exemplary embodiment of the present invention is described with reference to the drawings.

An information processing apparatus of the exemplary embodiment that is autonomously movable using an artificial intelligence is described.

The information processing apparatus functions as an apparatus in a real space that provides calculation resources to be used by the artificial intelligence.

The calculation resource refers to a resource that is used in a process or job executed by a computer. The calculation source is typically the sum of time throughout which the information processing apparatus uses a processor (processor time) and a memory (including a physical memory and a virtual memory).

The artificial intelligence is different from existing computer programs in that all input and output relations are not described in advance within the artificial intelligence.

The artificial intelligence affects a real space using a command issued to a hardware resource forming the information processing apparatus.

The exemplary embodiment relates to a narrow artificial intelligence that maximizes its ability in an individual particular field. However, the artificial intelligence may be not only a narrow artificial intelligence but also an artificial general intelligence that may address a variety of complex problems.

Available as an algorithm implementing the artificial intelligence is a machine learning algorithm that autonomously learns laws and rules in accordance with given information, and outputs results by applying to data a law or rule learned and generated.

In the artificial intelligence that uses a machine learning algorithm, a difference in types of, amounts of, learning time of, or weighting of information used in learning affects output results of the artificial intelligence.

In this sense, the artificial intelligences different in types of and amounts of information used in learning are examples of the artificial intelligences different in parameters related to learning.

Also available as an algorithm implementing an artificial intelligence is a deep-learning type algorithm that is implemented as machine learning using multi-layered neural networks.

The deep-learning type algorithm includes a method of using a convolutional neural network, a method of using a recurrent neural network, a method of using a deep belief network, and a method of using deep Boltzmann machine. Artificial intelligences different in implementation methods are example of artificial intelligences different in parameters related to learning.

Further, algorithms implementing the artificial intelligence may include a genetic algorithm, reinforcement learning, cluster analysis, self-organizing map (SOM), and ensemble learning.

In accordance with the exemplary embodiment, artificial intelligences different in algorithm are considered to be artificial intelligences different in algorithm method. The artificial intelligences different in algorithm and artificial algorithms different in parameter related to learning and an amount of learning are generally referred to as artificial intelligences different in method.

Each artificial intelligence has its own usefulness in terms of process content.

The artificial intelligence of the exemplary embodiment supports all or some of a functionality of handling language, a functionality of handling images, a functionality of handling audio, a functionality of performing control, and a functionality of optimization and inference.

The communication robot is an example of a robot having the functionality of handling language. The cleaning robot is an example of a robot having the functionality of performing control.

In accordance with the exemplary embodiment, the word “autonomous” refers to a state in which something is performed in a manner free from outside control. In other words, the word “autonomous” refers to a state that is self-contained and not dependent on other entities.

The information processing apparatus of the exemplary embodiment is specifically described. The information processing apparatus is present within the real space.

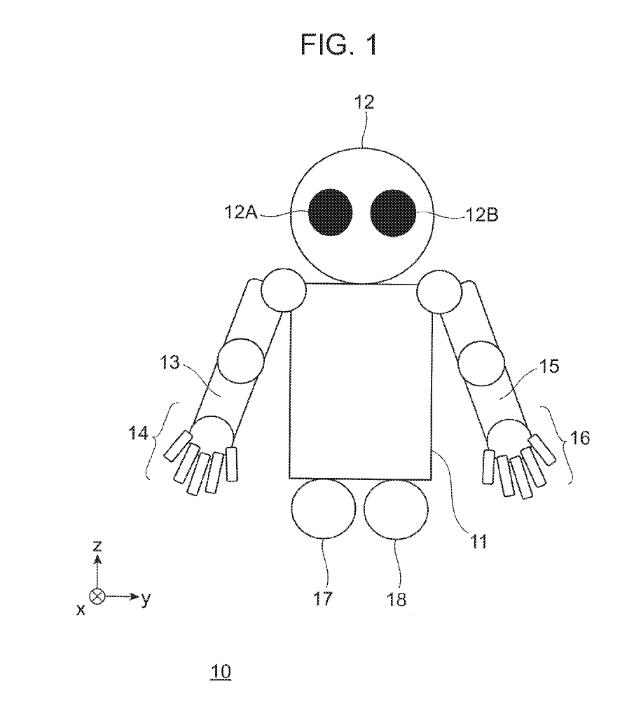

FIG. 1 illustrates an external view of a robot 10 that is an example of the information processing apparatus.

Referring to FIG. 1, the robot 10 has an external view of a human-like doll or a toy. The robot 10 is not limited to a doll-like shape, but may have a shape mimicking an animal, such as a dog or cat, a plant, such as a flower or tree, a vehicle (such as a train) or a airplane.

The humanoid robot 10 includes a trunk 11, a head 12, arms 13 and 15, hands 14 and 16, and legs 17 and 18.

The trunk 11 houses electronic components for signal processing. The trunk 11 may also include a display or an audio device.

The head 12 is connected to the trunk 11 via a joint mechanism disposed at the neck. In accordance with the exemplary embodiment, the joint mechanism is rotatable around three axes. The rotation around three axes include yawing (rotation around a z axis), rolling (rotation around an x axis), and pitching (rotation around a y axis).

The joint mechanism does not necessarily have to be rotatable around three axes, and may be rotatable around one axis only or two axes only. The joint mechanism may be rotated by a motor (not illustrated), or may be manually rotated. Alternatively, the head 12 may be secured to the trunk 11.

The head 12 includes eyes 12A and 12B. The eyes 12A and 12B may be disposed for decoration purposes or may include an imaging device, a projector, or an illumination device. The head 12 may also include movable ears.

In accordance with the exemplary embodiment, the arms 13 and 15 are connected to the trunk 11 via joint mechanisms. The upper arm and the lower arm of each of the arms 13 and 15 are connected to each other via a joint mechanism. As the joint mechanism, the head 12 may be of multi-axis or single-axis type. The joint mechanism may be rotated by a motor (not illustrated) or may be manually rotated. Alternatively, the arms 13 and 15 may be secured to the trunk 11.

When the arms 13 and 15 are bent at a predetermined angle, the robot 10 may carry a thing.

The hands 14 and 16 are respectively connected to the arms 13 and 15 via joint mechanisms disposed at the locations of the wrists. In each of the hands 14 and 16, fingers are connected to the palm via joint mechanisms. Like the joint of the head 12, the joint mechanism may be of multi-axis or single-axis type. The rotation around each axis may be driven by a motor (not illustrated) or may be manually driven. In accordance with the exemplary embodiment, each of the hands 14 and 16 may grip a thing by fingers that may be opened or closed.

Alternatively, the hands 14 and 16 may be secured to the arms 13 and 15, respectively.

The legs 17 and 18 may be connected to the trunk 11 via joint mechanisms. Alternatively, the legs 17 and 18 may be a self-propelled mechanism, such as wheels or caterpillars, and may be directly connected to the trunk 11.

If the legs 17 and 18 are connected to the trunk 11 via the joint mechanisms, the joint mechanisms may be of multi-axis or single-axis type like the joint mechanism of the head 12.

The rotation around each axis may be driven by a motor (not illustrated) or may be manually driven. Alternatively, each of the legs 17 and 18 may be secured to the trunk 11.

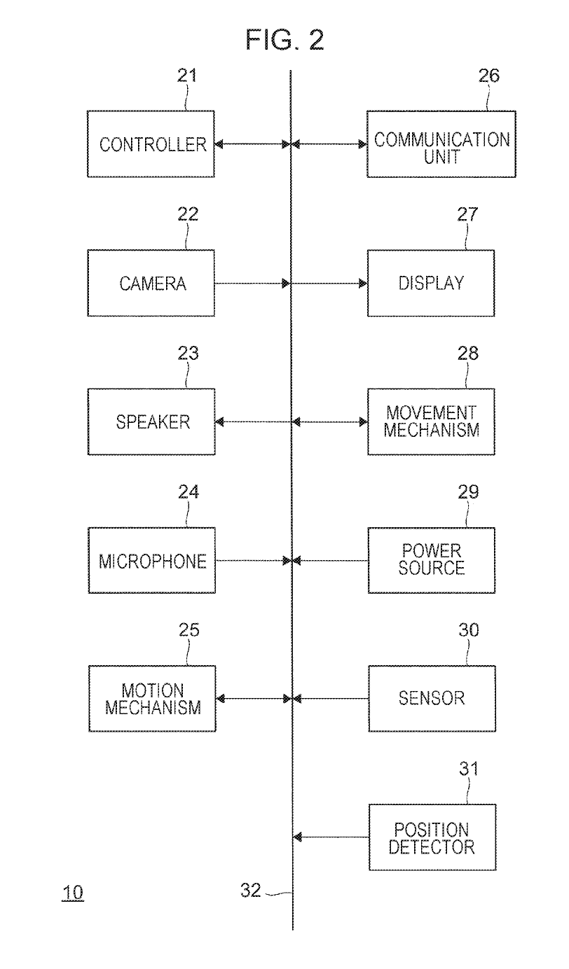

FIG. 2 illustrates a hardware configuration of the robot 10 for use in the exemplary embodiment.

The robot 10 includes a controller 21, a camera 22, a speaker 23, a microphone 24, a motion mechanism 25, a communication unit 26, a display 27, a movement mechanism 28, a power source 29, a sensor 30, and a position detector 31. These elements are interconnected to each other via a bus 32, for example. The controller 21 controls the movement of the whole apparatus. The camera 22 captures ambient images of the robot 10. The speaker 23 reproduces a conversation voice, music, and sound effect. The microphone 24 is used to input or pick up a sound. The motion mechanism 25 is a joint mechanism, for example. The communication unit 26 communicates with an external device. The display 27 displays images. The movement mechanism 28 moves the whole apparatus. The power source 29 feeds power to each element. The sensor 30 is used to collect information regarding the state of each element and peripheral information. The position detector 31 is used to acquire position information.

The hardware configuration of FIG. 2 is illustrated for the purpose of example. The robot 10 may not necessarily have to include all the functionality units described above.

The robot 10 may include another functionality unit (not illustrated). For example, the robot 10 may include a power button, a memory device (such as a hard disk device, or a semiconductor memory), and a heat source (including a cooling source).

The controller 21 is a computer, and includes a central processing unit (CPU), a read-only memory (ROM), and a random-access memory (RAM).

The ROM stores a program executed by the CPU.

The CPU reads the program stored on the ROM, and executes the program using the RAM as a working area. By executing the program, the CPU controls the elements forming the robot 10.

The program includes a program related to the implementation of an algorithm corresponding to the artificial intelligence. The CPU and RAM forming the controller 21 provide calculation resources to be used by the artificial intelligence.

With the artificial intelligence, the controller 21 of the exemplary embodiment processes information acquired by the camera 22, the microphone 24, and the sensor 30, and autonomously determines the operation of the robot 10 in response to the surrounding environment and state of the robot 10.

The controller 21 may emit a sound from the speaker 23, transmit a message via the communication unit 26, or output an image via the display 27.

The controller 21 thus establishes communication with a user in response to the input and output of these pieces of information and the motion of the motion mechanism 25. Application example of the communication may include waiting on customers or leading a conference.

If an unidentified event occurs, the controller 21 may have a functionality of collecting additional information via Internet searching or communication with an external computer, and finding a solution according to a degree of similarity with searched events.

In accordance with the exemplary embodiment, the information acquired by the controller 21 includes information gained through vision, hearing, tactile sensation, taste, sense of smell, sense of balance, and thermal sensation.

Vision may be implemented through a recognition process of an image captured by the camera 22.

Hearing may be implemented through a recognition process of a sound picked up by the microphone 24.

Tactile sensation may include superficial sensation (tactile sensation, algesia, and thermal sensation), deep sensation (sense of pressure, sense of position, vibratory sense, and the like), cortical sense (two-point discrimination, spatial perception, and the like).

The controller 21 may discriminate a difference in tactile sensation.

The tactile sensation, taste, sense of smell, sense of balance, and thermal sensation may be implemented when a variety of sensors 30 acquire information. The information gained by the thermal sensation includes an ambient temperature, an internal temperature, and a body temperature of a person or animal.

The information acquired by the controller 21 may include an electroencephalogram of a human or animal. The electroencephalogram may be obtained by receiving with the communication unit 26 information transmitted by an electroencephalogram sensing device.

In accordance with the exemplary embodiment, the camera 22 is disposed at the location of each of the eye 12A and the eye 12B (see FIG. 1).

If a projector is used as the display 27, the projector may be mounted at one of or both of the eyes 21A and 12B (see FIG. 1). Alternatively, the projector may be mounted at the trunk 11 or the head 12.

The motion mechanism 25 is used to transport a thing or express a feeling.

If the motion mechanism 25 is used to transport a thing, the motion mechanism 25 grips, holds, or supports the thing by changing the shape of the arms 13 and 15, and the hands 14 and 16 (see FIG. 1).

If the motion mechanism 25 is used to express a feeling, the motion mechanism 25 inclines the head 12 in doubt, looks up, looks around, raises the arms 13 and 15, or points a finger.

The communication unit 26 of the exemplary embodiment wirelessly communicates with the outside.

The robot 10 includes the communication units 26 whose number is equal to the number of communication schemes expected to be used in external devices serving as destinations.

The communication schemes include infrared communication, visible light communication, near field radio communication, WiFi (registered trademark), Bluetooth (registered trademark), RFID (registered trademark), ZigBee (registered trademark), IEEE802.11a (registered trademark), MulteFire, and low power wide area (LPWA).

Bands used in radio communication include short-wave band (800 MHz to 920 MHz), and 2.4 GHz band and 5 GHz band.

Note that the communication unit 26 may be connected to the external device using a communication cable.

The display 27 may be used to establish visual communication with the user. For example, the communication unit 26 may display characters or graphics.

If the display 27 is mounted on the head 12, the display 27 may display a facial expression.

In accordance with the exemplary embodiment, wheels or caterpillars are used for the movement mechanism 28. Alternatively, the robot 10 may be moved using the force of air, for example using a propeller or a mechanism that blows out compressed air.

The power source 29 of the exemplary embodiment is a rechargeable battery. As long as power is provided, the power source 29 may be a primary battery, a fuel cell, or a solar panel.

Alternatively, power may be supplied from the outside via a power cable.

The robot 10 of the exemplary embodiment includes the position detector 31.

The position detector 31 may be one of the following systems. The systems include a system that acquires position information from global positioning system (GPS) signals, an indoor messaging system (IMES) that measures a location within an indoor space using signals similar to the GPS signals, a WiFi positioning system that fixes a position from the intensities of radio waves transmitted from plural WiFi access points and arrival times of the radio waves, a basestation positioning system that fixes a position from a bearing and a delay time of a response responsive to a signal periodically generated from a basestation, an ultrasonic sounding system that fixes a position by receiving an ultrasonic wave in an inaudible range, a Bluetooth (registered trademark) positioning system that fixes a position by receiving a radio wave from a beacon using Bluetooth, a visible light positioning system that fixes a position using positioning information that is transmitted by blinking illumination light from a light-emitting diode (LED), and a dead-reckoning system that fixes a position using an acceleration sensor or gyro sensor.

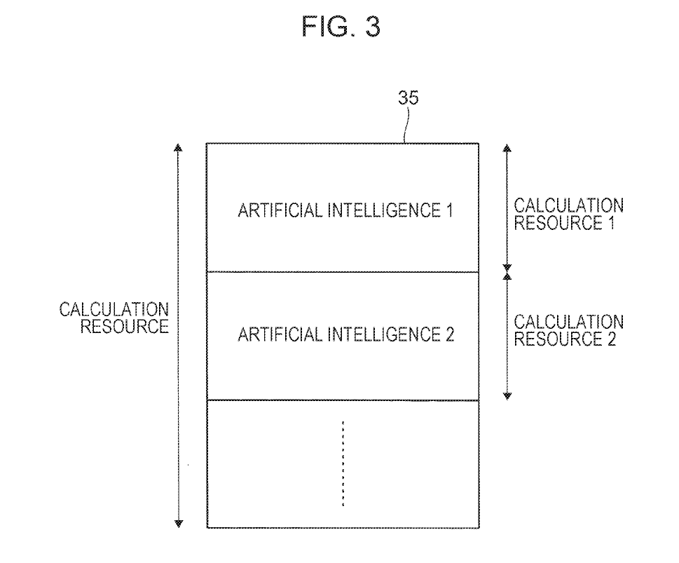

FIG. 3 illustrates a usage example of calculation resources provided by the robot 10.

In accordance with the exemplary embodiment, calculation resources 35 provided by the controller 21 are used in the operation of two artificial intelligences and a control program.

The two artificial intelligences are differentiated by referring to as “artificial intelligence 1”, and “artificial intelligence 2”. The artificial intelligence 1 is an example of a first artificial intelligence, and the artificial intelligence 2 is an example of a second artificial intelligence.

In accordance with the exemplary embodiment, the artificial intelligence 1 and the artificial intelligence 2 are different from each other. Examples of different artificial intelligences are artificial intelligences that are different in algorithm methods, or in parameter related to learning even if the same algorithm method is used.

If different algorithm methods are used, the artificial intelligence 1 may use a machine learning type algorithm, and the artificial intelligence 2 may use a deep learning type algorithm.

If the parameters related to learning are different even though the same algorithm method is used, the artificial intelligence 1 may use a deep learning algorithm having a learning period of one year, and the artificial intelligence 2 may use a deep learning algorithm having a learning period of two years.

Further, the examples of different artificial intelligences may be artificial intelligences with weight of learning data (data prioritized) differently modified.

The difference in algorithm method or the difference in parameter may lead to a process time until process results are obtained. Note that the process time also depends on the available calculation resources.

In accordance with the exemplary embodiment, the artificial intelligence 1 and the artificial intelligence 2 share the calculation resources. Alternatively, the calculation resource used by the artificial intelligence 1 may be physically different from the calculation resource used by the artificial intelligence 2.

Given the same input information, the artificial intelligence 1 and the artificial intelligence 2 may not necessarily give the same process results if the artificial intelligence 1 and the artificial intelligence 2 use different algorithms.

On the other hand, if the artificial intelligence 1 and the artificial intelligence 2 give the same process results, the process results are considered to be more reliable because they are obtained as a result of assessment from a variety of angles.

A portion of the calculation resource of FIG. 3 that is not used by the artificial intelligence 1 and the artificial intelligence 2 may be used in a determination to combine the process results of the artificial intelligence 1 and the artificial intelligence 2 or may be used in a control operation of elements (such as the speaker 23, the motion mechanism 25, the communication unit 26, the display 27, and the movement mechanism 28) in response to content of the determination.

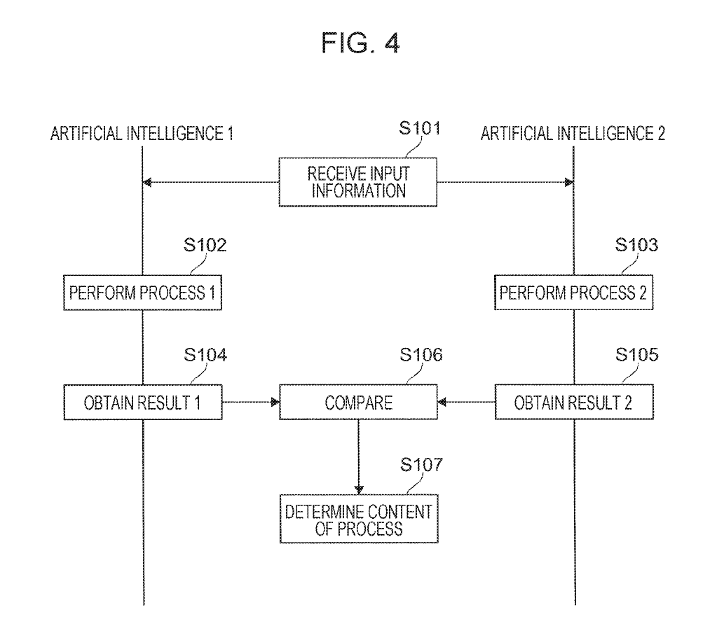

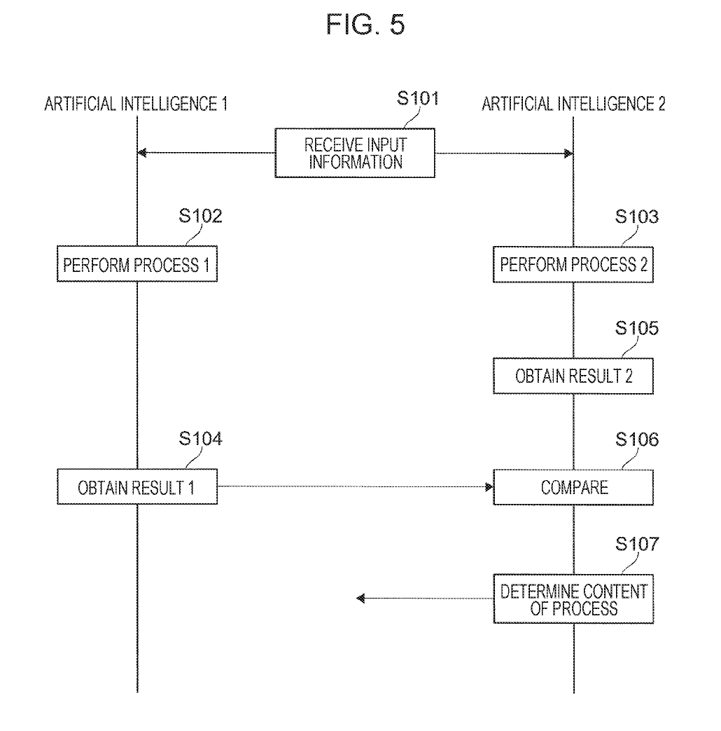

FIG. 4 and FIG. 5 illustrate a mechanism through which process results of two artificial intelligences are combined. FIG. 4 illustrates a mechanism through which two process results are combined via a process functionality other than those of two artificial intelligences. FIG. 5 illustrates a mechanism through which two process results are combined by one of the two artificial intelligences.

Referring to FIG. 4, the artificial intelligence 1 and the artificial intelligence 2 receive identical input information (step S101).

The artificial intelligence 1 and the artificial intelligence 2 respectively perform a process 1 and a process 2 in accordance with individual algorithms thereof (steps S102 and 103), and respectively obtain a result 1 and a result 2 (steps S104 and S105).

The two results 1 and 2 are supplied to a control program that is executed by the controller 21, and compared there (step S106). The control program is an existing program that describes all input and output relationships in advance.

The control program compares the two results 1 and 2, and determines content of a process to be performed next in response to comparison results (step S107).

If the result 1 matches the result 2, the control program determines a predetermined one of the process results (the result 1 of the artificial intelligence 1, for example) to be an output. In response to an external environment recognized, the control program controls the movement mechanism 28, thereby moving the robot 10 in a real space. For example, the control program generates a sound responsive to recognized voice content through the speaker 23. For example, the control program expresses a feeling in response to a recognized input from the outside, by driving the arms 13 and 15 with the motion mechanism 25.

If the result 1 is different from the result 2, the control program determines to be an output the result of the artificial intelligence that is in a higher-ranking position. For example, the result 1 of the artificial intelligence 1 may be selected.

Alternatively, the control program may instruct each of the artificial intelligence 1 and the artificial intelligence 2 to perform the processes thereof again. In such a case, the control program attaches an additional condition to the input information. The additional condition is predetermined, depending on the input information. The attachment of the additional condition may work in a manner such that the option range of the result 1 obtained through the process by the artificial intelligence 1 is narrowed. The control program instructs the artificial intelligence 1 and the artificial intelligence 2 to repeatedly perform the processes thereof until the result 1 matches the result 2.

Even after the processes are repeatedly performed, the two results, namely the result 1 and the result 2, may possibly fail to match, and in such a case, the robot 10 may suspend the operation thereof.

Although there is a case where the robot 10 is allowed to suspend the operation thereof, a response may be desired within a predetermined period of time as in the case of a self-driving application. In such a case, under the condition that the predetermined period of time has elapsed or a predetermined number of iterations has been exceeded, the control program is designed to determine content of a process to be performed next, based on the premise that one predetermined result (the result 2 of the artificial intelligence 2, for example) is to be output (in other words, is processed with a higher priority).

Each of the result 1 of the artificial intelligence 1 and the result 2 of the artificial intelligence 2 may include plural pieces of information. If full matching of all the pieces of information between the artificial intelligence 1 and the artificial intelligence 2 is desired, it may possibly take time for the result 1 and the result 2 to match each other.

In view of this, the control program may have a functionality that performs comparison on some of the plural pieces of each of the result 1 and the result 2. The some of the information may be predetermined depending on a control item that is subject to a time limit. In this way, the time to determine is shortened.

The process of FIG. 5 is different from the process of FIG. 4 in that the process of FIG. 5 includes a comparison operation (step S106) and a determination operation (step S107) to be performed next are performed by the artificial intelligence 2. Alternatively, the comparison operation (step S106) and the determination operation (step S107) to be performed next may be performed by the artificial intelligence 1.

In such a case, the artificial intelligence is involved in the determination operation, and learning results may be reflected on a determination as to which process result is to be used, depending on an operational status. In view of this, the process of FIG. 5 is improved from the process of FIG. 4 in terms of reliability of the determination operation.

The determined process is provided to the control program that operates separately from the artificial intelligence 1 and the artificial intelligence 2, and the operation of the robot 10 is thus controlled in accordance with a predetermined input and output relationship.

In the discussion above, two artificial intelligences, the artificial intelligences 1 and 2, basically have equal ranking, increase the reliability of the process results of artificial intelligences through the comparison of the result 1 and the result 2. One of the artificial intelligences 1 and 2 may have a worker's role, and the other of the artificial intelligences 1 and 2 may have a monitor's role.

A coordinated operation performed between the robot 10 in the real space and a display screen (virtual space) of a terminal apparatus is described below.

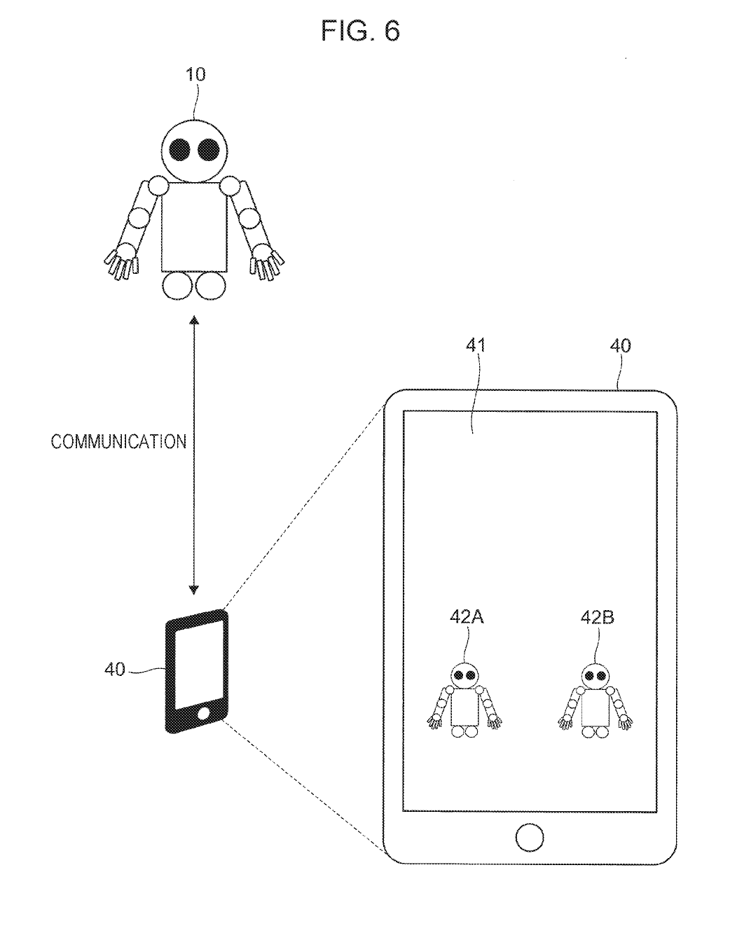

FIG. 6 illustrates the coordinated operation between the real space and the virtual space.

The robot 10 and a terminal apparatus 40 are both physically present in the real space, and remain communicable with each other via a communication link.

The terminal apparatus 40 may be an electronic apparatus including a display screen 41 and a communication unit (not illustrated). For example, the terminal apparatus 40 may be (1) information apparatus, such as a notebook computer, a desktop computer, a tablet computer, a smart watch, a smart phone, a digital camera, a video camera, or a game machine, (2) home appliance, such as a refrigerator, a cooking machine, or a washing machine, (3) housing equipment, such as a home appliance monitor, or (4) vehicle, such as a car. The terminal apparatus 40 is an example of an information processing apparatus.

Displayed on the display screen 41 of the terminal apparatus 40 of the exemplary embodiment are a character 42A and a character 42B respectively associated with the artificial intelligence 1 and the artificial intelligence 2 (see FIG. 3), each operating on the robot 10.

A user of the terminal apparatus 40 recognizes the operational status of the robot 10 in the real space via the characters 42A and 42B in the virtual space displayed on the display screen 41 and instructs the robot 10 to perform a desired operation.

The character 42A corresponds to the artificial intelligence 1, and the character 42B corresponds to the artificial intelligence 2.

Via the characters 42A and 42B, the user may visually recognize the artificial intelligence 1 and the artificial intelligence 2 that are entities in the virtual space.

The characters 42A and 42B on the display screen 41 may move in concert with the movement of the robot 10 in the real space. The user may recognize the operational status of the robot 10 by referring to the movement of the characters 42A and 42B on a real-time basis even if the terminal apparatus 40 is spaced apart from the robot 10 in the real space.

The characters 42A and 42B are not different in design as illustrated in FIG. 6. If the artificial intelligence 1 and the artificial intelligence 2 respectively have a worker's role and a monitor's role, the two artificial intelligences may be differentiated in display dimension, display color, or display shape.

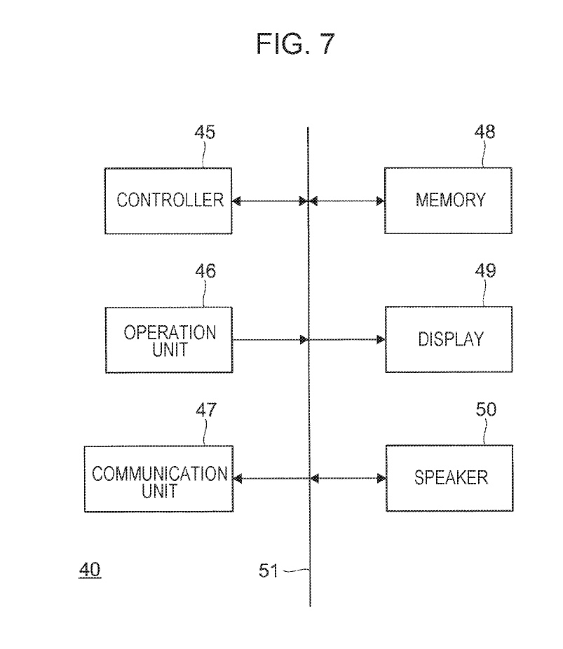

FIG. 7 illustrates a hardware configuration of the terminal apparatus 40.

The terminal apparatus 40 includes a controller 45, an operation unit 46, a communication unit 47, a memory 48, a display 49, and a speaker 50. The controller 45 controls the movement of the whole apparatus. The operation unit 46 receives an operational input from the user. The communication unit 47 is used to communicate with an external apparatus (such as the robot 10). The memory 48 stores information. The display 49 displays an image. The speaker 50 outputs a voice, music, and sound effects. These elements are interconnected to each other via a bus 51.

The controller 45 is a computer, and includes a CPU, a ROM, and a RAM. The ROM stores a program that is executed by the CPU. The CPU reads the program from the ROM, and executes the program using the RAM as a working area. By executing the program, the CPU controls the operation of each element forming the terminal apparatus 40.

The program implements a functionality of displaying on the display 49 the characters 42A and 42B respectively corresponding to the artificial intelligence 1 and the artificial intelligence 2 operating on the robot 10.

The operation unit 46 includes a keyboard, buttons, switches, a touchpad, a touchpanel, and the like.

The communication unit 47 communicates with the robot 10 via a radio communication link or any other communication link.

The memory 48 includes a storage device, such as a hard disk device or a semiconductor memory.

The display 49 displays a variety of images when programs (including an operating system (OS), and firmware) are executed. The display 49 may be a liquid-crystal display or an electroluminescent (EL) display.

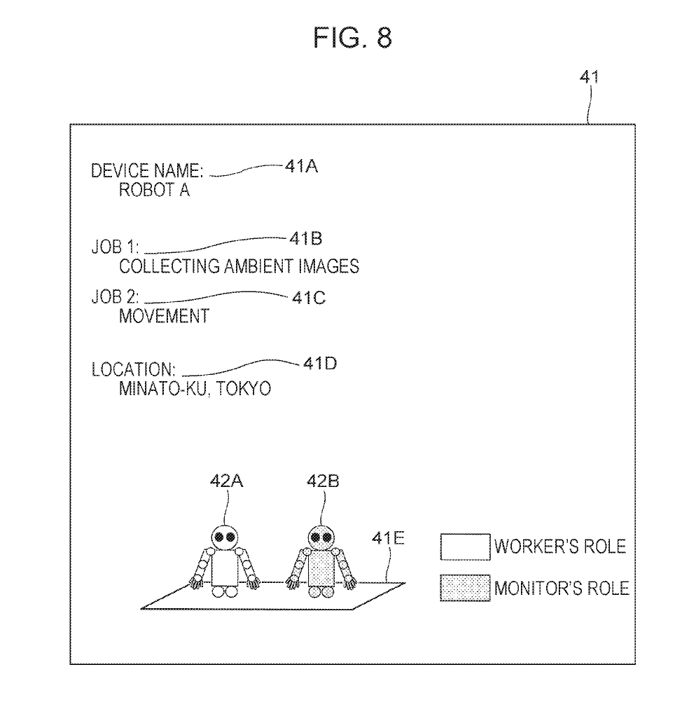

The coordinated operation between the real space and the virtual space is described with reference to FIG. 8 through FIG. 12.

FIG. 8 illustrates a display example of the display screen 41. Referring to FIG. 8, the display screen 41 displays a device name 41A corresponding to the virtual space displayed on the display screen 41, jobs 41B and 41C performed by the artificial intelligence 1, and a location 41D where the robot 10 corresponding to the device name 41A is located in the real space.

Referring to FIG. 8, a “robot A” is listed as the device name 41A. Displayed on the same screen are the characters 42A and 42B respectively associated with the artificial intelligence 1 and the artificial intelligence 2 that perform a process of the robot A.

The user viewing the display screen 41 may learn that the robot 10 (robot A) operating in a remote place is collecting ambient images (job 1), and is moving (job 2).

Referring to FIG. 8, the artificial intelligence 1 (the character 42A) operates as a worker, and the artificial intelligence 2 (the character 42B) operates as a monitor.

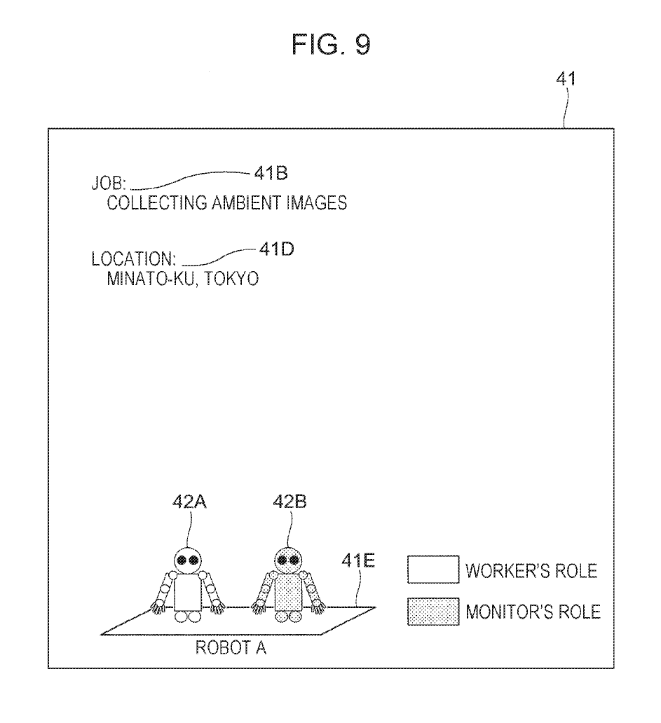

FIG. 9 illustrates another display example on the display screen 41. The display screen 41 of FIG. 9 is different from the display screen 41 of FIG. 8 in that the device name 41A is displayed on the display screen 41 of FIG. 9 as a name of an activity region 41E of the virtual space of the artificial intelligence 1 (the character 42A) and the artificial intelligence 2 (the character 42B).

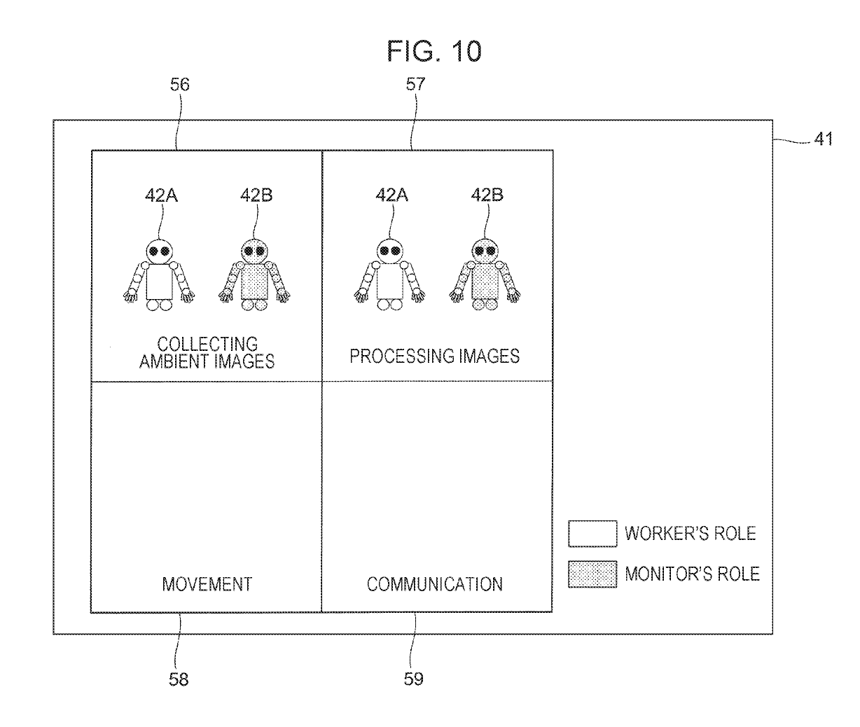

FIG. 10 illustrates another display example on the display screen 41. Four working spaces 56 through 59 are displayed as virtual spaces on the display screen 41 of FIG. 10.

The working space 56 indicates a collection operation of the ambient images, the working space 57 indicates an operation of processing an image, the working space 58 indicates a movement operation, and the working space 59 indicates communication.

Referring to FIG. 10, the artificial intelligence 1 (the character 42A) and the artificial intelligence 2 (the character 42B) perform two jobs of the working space 56 (the collection operation of the ambient images) and the working space 57 (processing the images).

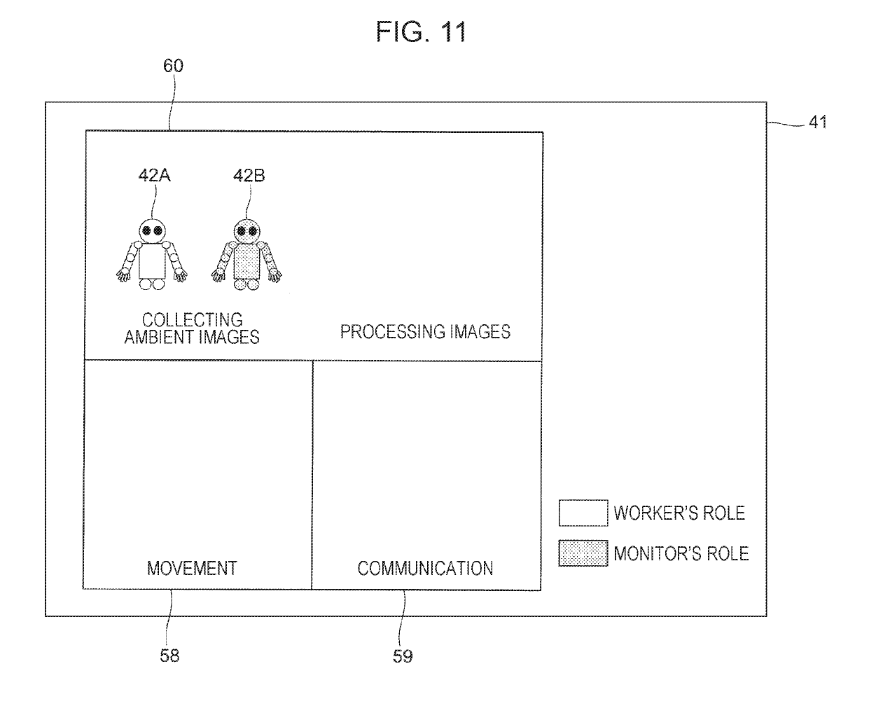

FIG. 11 illustrates another display example on the display screen. The display screen 41 of FIG. 11 displays a working spaces 60 including to plural working spaces, and displays the character 42A corresponding to the artificial intelligence 1 and the character 42B corresponding to the artificial intelligence 2.

Even if more processes are performed in parallel by the artificial intelligences 1 and 2 on the display screen 41 of FIG. 11, an increase in the number of displays of the characters 42A and 42B is controlled, and the content of jobs is easily verified.

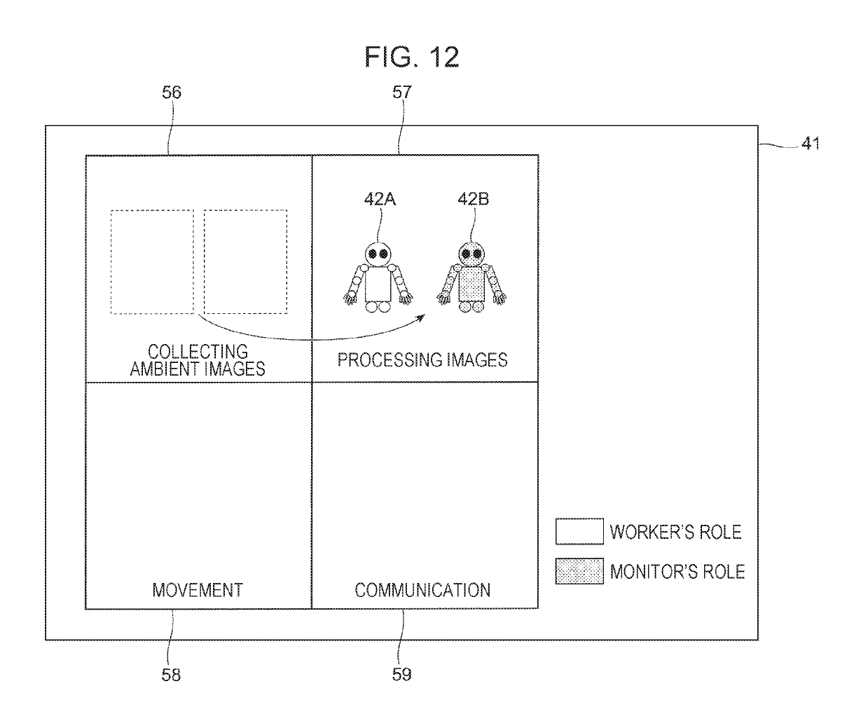

FIG. 12 illustrates another display example on the display screen 41. FIG. 12 illustrates the case in which the artificial intelligence 1 (the character 42A) having a worker's role and the artificial intelligence 2 (the character 42B) having a monitor's role have moved from a working space 56 (the collection operation of the ambient images) to a working space 57 (processing the images) in the virtual space.

The movement of the characters 42A and 42B in the virtual space represents the movement of the robot 10 (robot A) located in the real space. The user may recognize the operational status of the robot 10 (robot A) via the movement in the virtual space.

Since the artificial intelligence 1 (the character 42A) having the worker's role and the artificial intelligence 2 (the character 42B) having the monitor's role move together in the virtual space as illustrated in FIG. 12, the user may visually recognize the coordinated relationship of the artificial intelligence 1 and the artificial intelligence 2.

In the above discussion, the artificial intelligences 1 and 2 move in the virtual space corresponding to the robot 10. Alternatively, the artificial intelligences 1 and 2 may move to another apparatus that is connected to the robot 10 via a communication link.

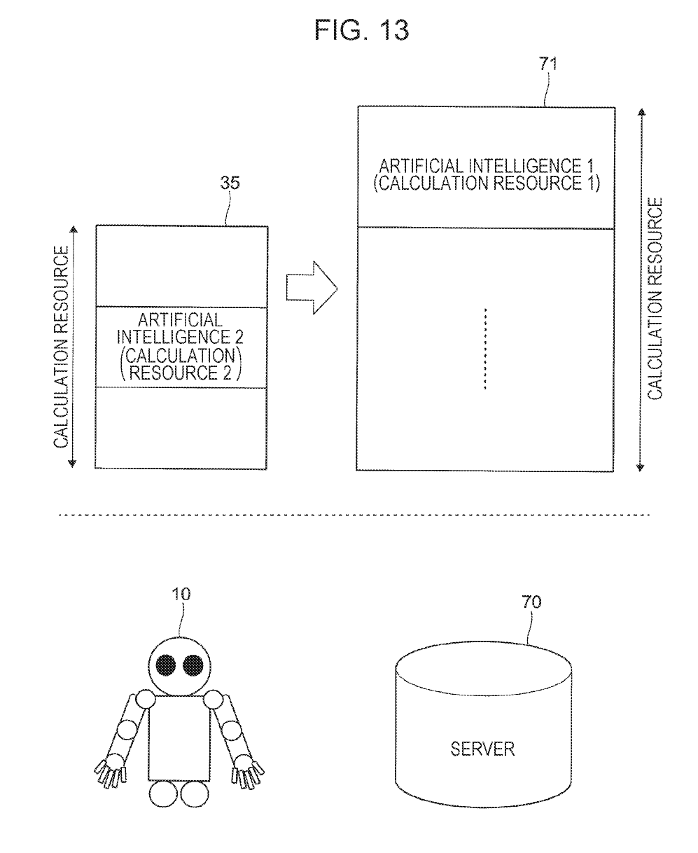

FIG. 13 illustrates a process in which an artificial intelligence moves. Referring to FIG. 13, the artificial intelligence 1 having a worker's role has moved from a calculation resource 35 corresponding to the robot 10 to a calculation resource 71 corresponding to a server 70. The server 70 is an example of the information processing apparatus.

The movement is performed through communication between the robot 10 and the server 70. More specifically, a set of data implementing an algorithm of the artificial intelligence 1 (a program, learning data, a parameter, and the like) is transmitted from the robot 10 to the server 70. Since the calculation resource 71 provided by the server 70 is typically broader than the calculation resource 35 provided by the robot 10, the operation of the artificial intelligence 1 moved to the server 70 is expedited.

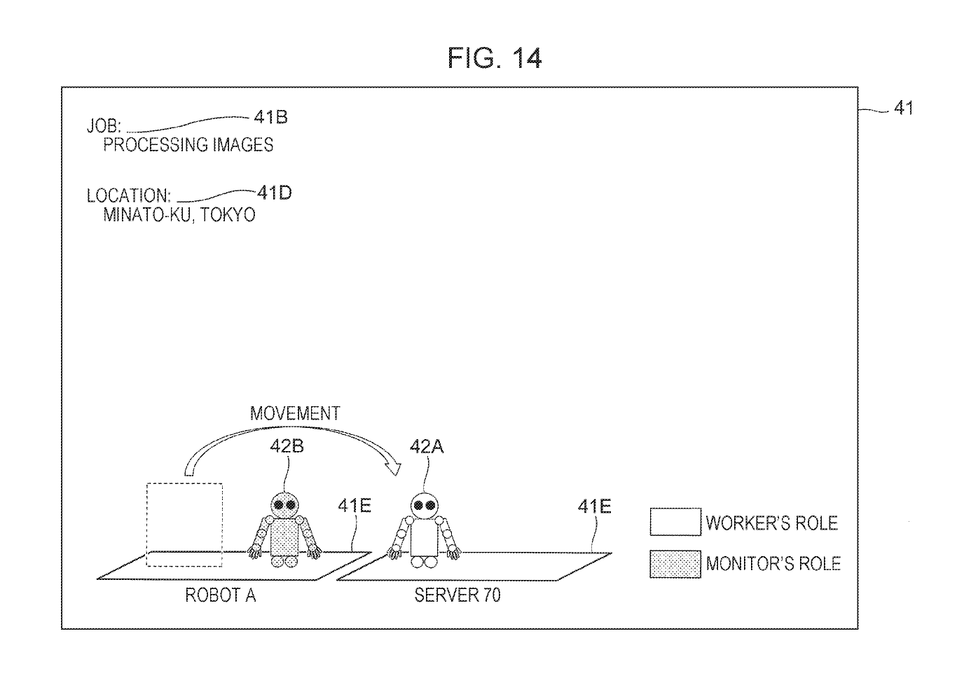

FIG. 14 illustrates a display example on the display screen 41 responsive to a movement process of the artificial intelligence 1. Referring to FIG. 14, an activity region 41E of the character 42A corresponding to the artificial intelligence 1 having a worker's role is moved from the robot A to the server 70.

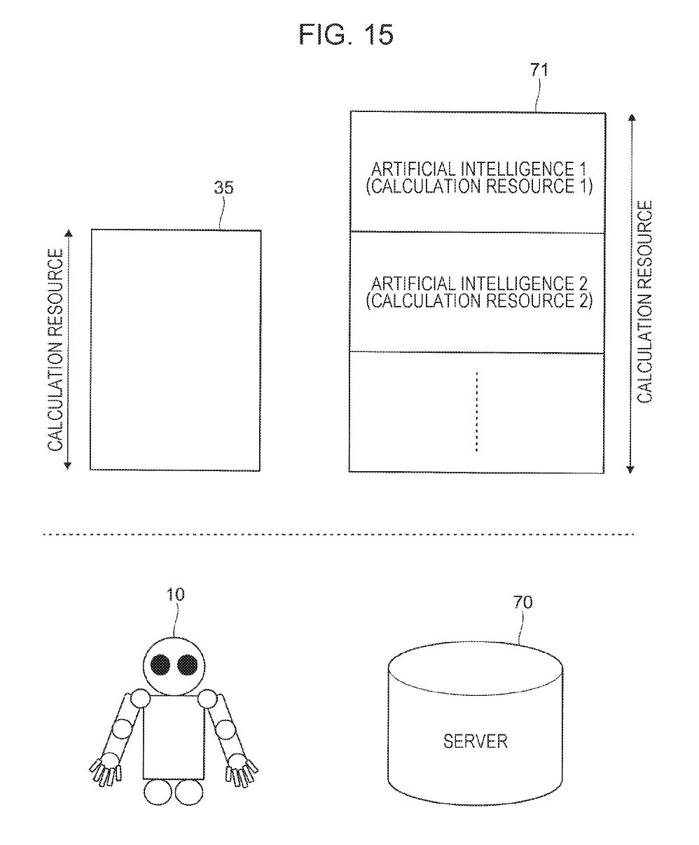

FIG. 15 illustrates a state in which the movement of the artificial intelligences 1 and 2 is complete. Referring to FIG. 15, the artificial intelligence 1 having a worker's role and the artificial intelligence 2 having a monitor's role have moved from the calculation resource 35 corresponding to the robot 10 to the calculation resource 71 corresponding to the server 70. Since the artificial intelligence 1 having the worker's role and the artificial intelligence 2 having the monitor's role have moved in a coordinated way, the reliability of the process results is increased.

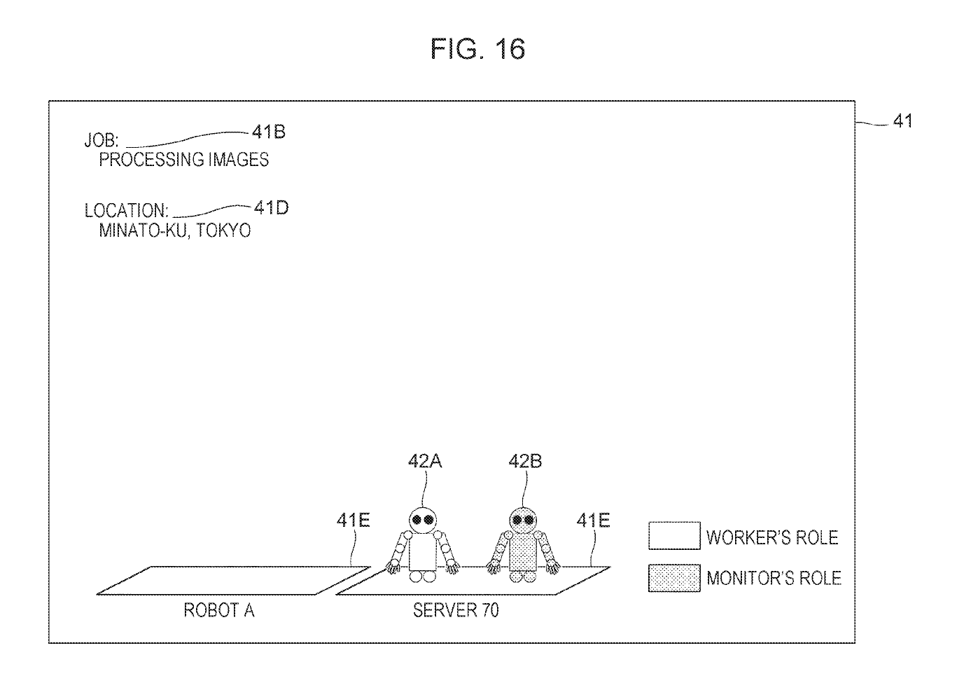

FIG. 16 illustrates a display example on the display screen 41 responsive to a phase in which the movement of the artificial intelligences 1 and 2 is complete. Referring to FIG. 16, the activity region 41E of the character 42B corresponding to the artificial intelligence 1 having the monitor's role has also moved from the robot A to the server 70.

The display screen 41 of FIG. 14 and FIG. 16 displays the movement of the working space in the virtual space of the characters 42A and 42B respectively corresponding to the artificial intelligences 1 and 2. Via the displaying, the user may learn that a processing functionality related to a recognition process and an examination process of the robot A present in the real space is performed on the server 70.

Even if the processing functionality is transferred from the robot A to the server 70, the process results may be provided to the robot A through the communication link. Since the control program operating in accordance with a predetermined rule is executed on the calculation resource 35 of the robot A, the operation of the robot A continues.

In accordance with the above discussion, both the artificial intelligence 1 having the worker's role and the artificial intelligence 2 having the monitor's role are operative on a single robot. The two artificial intelligences, namely the artificial intelligence 1 and the artificial intelligence 2, may be operative on different apparatuses.

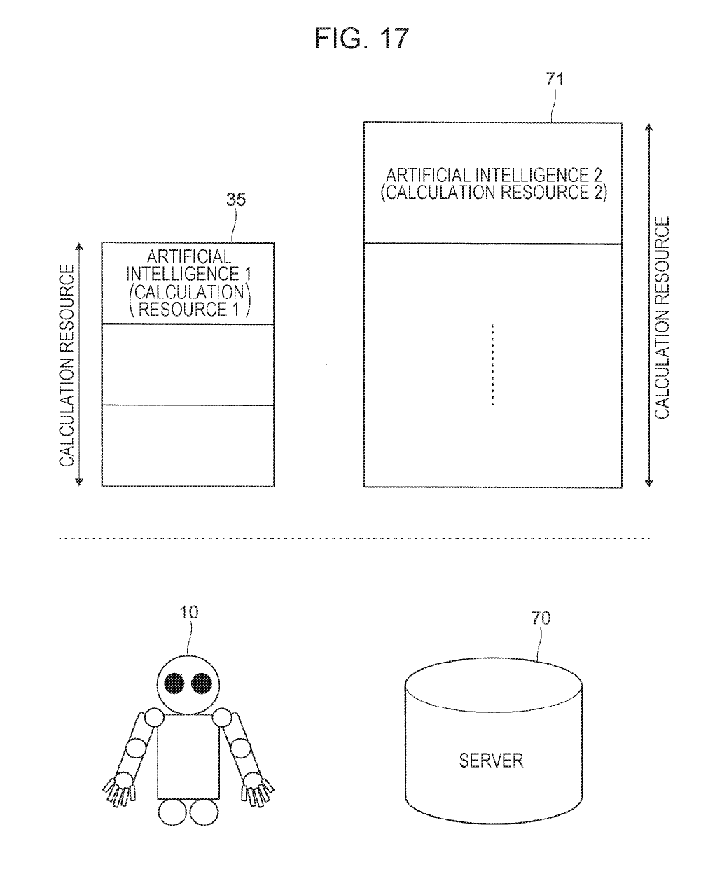

FIG. 17 illustrates an operation example in which the artificial intelligence 1 having the worker's role and the artificial intelligence 2 having the monitor's role operate in separate apparatuses. Referring to FIG. 17, the artificial intelligence 1 having the worker's role is operative on the calculation resource 35 of the robot 10 while the artificial intelligence 2 having the monitor's role is operative on the calculation resource 71 of the server 70. In this case, a ratio of the calculation resource 35 that is occupied by the artificial intelligence 1 is reduced, and an increase in the process efficiency is expected.

The deployment of the artificial intelligences illustrated in FIG. 17 may be used when information with higher confidentiality, such as personal information, is handled.

Personal information related to a user of the robot 10 is provided directly to the artificial intelligence 1 on the robot 10 as the input information while encrypted information for statistical processing is provided to the artificial intelligence 2 on the server 70 as the input information. In other words, the artificial intelligence 1 processes the input information as the personal information while the artificial intelligence 2 processes as the input information the information that is encrypted such that individuals are not identified. If the process results include information that may identify an individual, the information that is encrypted is transmitted from the robot 10 to the server 70.

Another method of handling information having a higher degree of encryption may include switching between an artificial intelligence (specialized artificial intelligence) handling information having a higher degree of encryption and an artificial intelligence (general-purpose intelligence) handing information having a relatively lower degree of encryption. For example, information having a higher degree of encryption, out of information to be processed, is processed by one or more specialized artificial intelligences different in scheme from the general-purpose artificial intelligence, and after the information is processed by one or more specialized artificial intelligences, the processing is taken over by the general-purpose artificial intelligence. In this case, leakage of the information having the higher degree of encryption is controlled and accumulation of the information having the higher degree of encryption in the general-purpose artificial intelligence is also controlled.

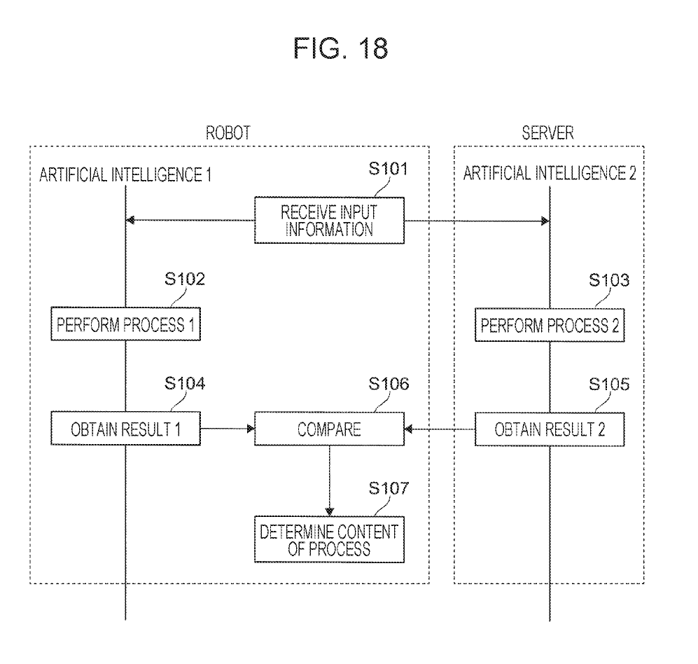

FIG. 18 illustrates a combined operation of two results when two artificial intelligences operate in separate apparatuses. The process of FIG. 18 is identical to the process of FIG. 4 except that the execution entity of each operation includes the robot 10 and the server 70 in the process of FIG. 18. As in the process of FIG. 5, the comparison operation and the determination operation to determine the content of the process to be performed next may be performed by the server 70.

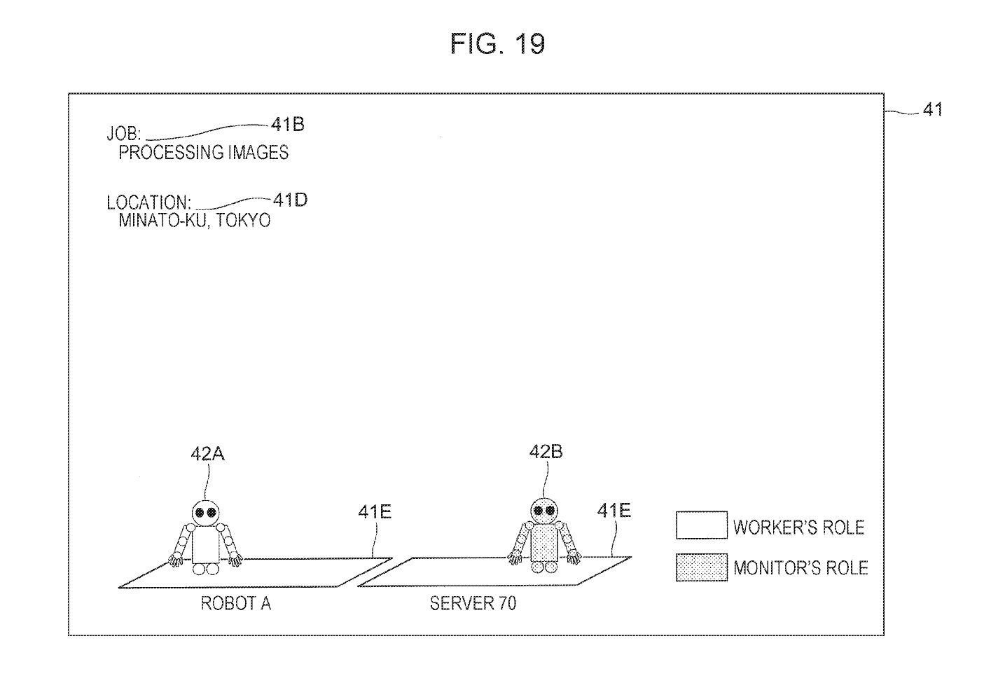

FIG. 19 illustrates a display example on the display screen 41 when the artificial intelligences and 2 operate in separate apparatuses. With reference to FIG. 19, the user recognizes that the artificial intelligence 1 having the worker's role (the character 42A) operates on the robot A and the artificial intelligence 2 having the monitor's role (the character 42B) operates on the server 70.

In the above discussion of the exemplary embodiment, the characters 42A and 42B move in the virtual space in a coordinated operation of the artificial intelligences 1 and 2 moving in the real space. Alternatively, the working location of the artificial intelligences 1 and 2 may be moved by performing a movement operation to the characters 42A and 42B on the display screen 41.

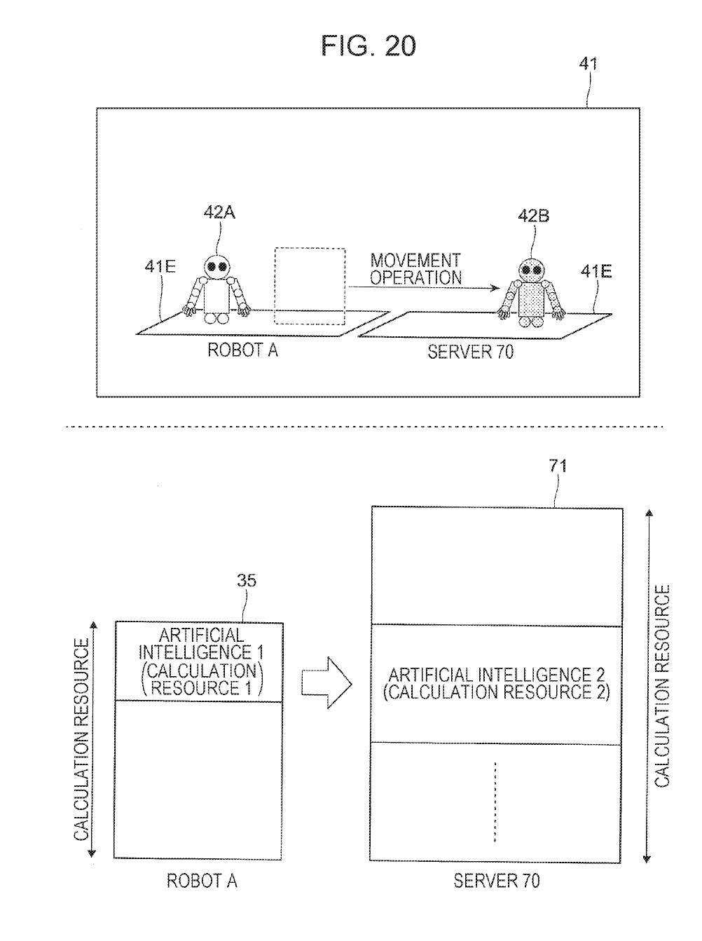

FIG. 20 illustrates how the working location of the artificial intelligence moves in concert with an operation performed on the character 42B on the display screen 41.

Referring to FIG. 20, the character 42B, out of the characters 42A and 42B corresponding to the artificial intelligences 1 and 2, is moved from the robot A to the server 70 on the display screen 41. Content of the movement operation is transmitted from the terminal apparatus 40 to the robot A.

In response to a received movement command, the robot A transmits to a specified server a set of data to implement the artificial intelligence 2 (programs, learning data, and parameters), thereby completing the movement of the artificial intelligence 2 in the real space.

In this way, the user performs the operation in the real space in a seamless fashion via a character on the display screen 41 (virtual space). In this case, as well, the process results of the artificial intelligence 1 operative on the robot A are monitored by the artificial intelligence 2 operative on the server 70, and the reliability of the operation of the robot A is thus increased.

The exemplary embodiment has been described. The scope of the present invention is not limited to the scope of the exemplary embodiment described above. Changes and modifications are possible to the exemplary embodiment, and the exemplary embodiment with these changes and modifications applied thereto also falls within the scope of the present invention as described with reference to the scope of the claims.

In accordance with the exemplary embodiment, the two artificial intelligences operate on the calculation resource 35 of the robot 10, or on the calculation resource 71 of the server 70, or operate in a distributed fashion on the calculation resource 35 of the robot 10 and the calculation resource 71 of the calculation resource 71. Alternatively, three or more artificial intelligences may operate on a single calculation resource or may operate on plural calculation resources in a distributed fashion.

In such a case, one of the artificial intelligences may be used as a worker, and another of the artificial intelligence may be used as a monitor. The three or more artificial intelligences are desirably different in method. The use of the artificial intelligences of different methods allows assessment to be performed from a variety of angles, and the reliability of the process results is even more increased.

When the process results of three or more artificial intelligences are compared, a higher priority (more emphasis) may be placed on the process results of one of the artificial intelligences than the process of the other artificial intelligences. Alternatively, a majority decision rule may be introduced to determine that the larger number of results having the same content are determined to be more correct. If the majority decision rule is introduced, the accuracy level of the process results is increased, and the artificial intelligences find applications in a more sophisticated problem-solving process.

In accordance with the exemplary embodiment, one of the artificial intelligences serves as a monitor. Alternatively, the two artificial intelligences may be coordinated with each other to perform an operation related to a single process. The process content may be split between the two artificial intelligences in advance, and a predetermined artificial intelligence may be designed to be in charge of a specific process.

As in the display 49 of the terminal apparatus 40, a character associated with an artificial intelligence may be displayed on the display 27 of the robot 10. The use of the character displayed on an apparatus (not limited to the robot 10) on which an artificial intelligence is operative allows the user to visually recognize the number of and the roles of artificial intelligences operative on the apparatus.

In accordance with the exemplary embodiment, the information processing apparatus on which the artificial intelligences 1 and 2 are operative is the robot 10. It is sufficient if the information processing apparatus includes hardware that provides a calculation resource. The information processing apparatus may take the form of a notebook computer, a tablet computer, a server, a smart watch, a smart phone, a digital camera, a video camera, a voice recorder, a medical apparatus, a car, a train, a ship, an airplane, or a drone.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first artificial intelligence that outputs a first result by processing input information; and
a second artificial intelligence that is different from the first artificial intelligence, and outputs a second result by processing the input information,
wherein content of a process to be performed next is determined, based on results obtained by comparing the first result with the second result.

2. The information processing apparatus according to claim 1, wherein the first artificial intelligence is associated with a first character that is movable in a virtual space, and the second artificial intelligence is associated with a second character that is movable in the virtual space.

3. The information processing apparatus according to claim 2, wherein the first character and the second character are displayed on a display screen of a terminal apparatus when communication is made with the terminal apparatus.

4. The information processing apparatus according to claim 3, wherein the second character moves together with the first character when the first character moves in the virtual space.

5. The information processing apparatus according to claim 1, wherein the first artificial intelligence and the second artificial intelligence move to another information processing apparatus that is connected to the information processing apparatus via a communication link.

6. The information processing apparatus according to claim 5, wherein the first artificial intelligence and the second artificial intelligence are moved in response to a movement operation that is performed on a display screen of a terminal apparatus to one of or both of the first character associated with the first artificial intelligence and the second character associated with the second artificial intelligence.

7. The information processing apparatus according to claim 1, wherein the second result has a priority over the first result if the first result is different from the second result.

8. The information processing apparatus according to claim 1, wherein the content of the process to be performed next is determined, based on results obtained by comparing part of the first result with part of the second result.

9. The information processing apparatus according to claim 1, wherein the first artificial intelligence and the second artificial intelligence are different in method.

10. The information processing apparatus according to claim 1, wherein the first artificial intelligence and the second artificial intelligence are identical in method but different in terms of parameters related to learning.

11. An information processing system comprising:
a first information processing apparatus including a first artificial intelligence that operates to output a first result by processing input information; and
a second information processing apparatus including second artificial intelligence that is different from the first artificial intelligence and operates to output a second result by processing the input information,
wherein content of a process to be performed next is determined, based on results obtained by comparing the first result with the second result.

12. A non-transitory computer readable medium storing a program causing a computer to execute a process for processing information, the process comprising:
inputting a first process result that first artificial intelligence has obtained by processing input information;
inputting a second process result that second artificial intelligence, different from the first artificial intelligence, has obtained by processing the input information; and
determining content of a process to be performed next, based on results obtained by comparing the first process result with the second process result.
